(19) United States
(12) Patent Application Publication
(10) Pub. No.: US 2004/0150674 A1
(43) Pub. Date: Aug. 5, 2004

(54) Information display system for vehicle

(75) Inventors: Toshiaki Takahashi, Yokohama-shi (JP); Hirofumi Inoue, Yokosuka-shi (JP)

Correspondence Address: McDERMOTT, WILL & EMERY, 600 13th Street, N.W., Washington, DC, 20005-3096, US

(73) Assignee: NISSAN MOTOR CO., LTD.

(21) Appl. No.: 10/761,363

(22) Filed: Jan. 22, 2004

(30) Foreign Application Priority Data
Feb. 2, 2003 (JP) P 2003 - 042644
Feb. 2, 2003 (JP) P 2003 - 042451

(51) Int. Cl. G09G 5/00

(52) U.S. Cl. 345/810

(57) ABSTRACT

A display system for a vehicle, which presents menu items corresponding to functions of vehicle mounted devices/equipment, displaying operation menus including some of the menu items on a screen, and allows a user to select one of the functions of vehicle mounted devices/equipment. The system includes: an input unit; an operatability judgment unit which judges user's operatability of the input unit; a storage unit which stores hierarchically structured first menu information; and a display control unit. The first menu information includes a plurality of the operation menus respectively registered in a plurality of tiers thereof. The display control unit determines the operation menu for displaying, based upon the operatability of the user, using the first menu information or a second menu information having a limited number of tiers as compared with the first menu information.

### BACKGROUND OF THE INVENTION

1. Field of Invention

The present invention relates to an information display system for a vehicle, which allows various operations of a user, selecting the optimum display contents for presenting to the user.

2. Description of Related Art

Japanese Patent Application Laid-Open Publication No. 2001-033256 discloses an in-car electronic device whose functions are restricted depending on a driving load condition, specifically, some functions thereof are disabled while the vehicle is in motion and menu items of the disabled functions are displayed in gray.

Japanese Patent Application Laid-Open Publication No. 7-098641 discloses a menu display method with a learning function, which rearranges a menu structure based upon a user's selection history so as to reduce the operations needed to select frequently used functions.

### SUMMARY OF THE INVENTION

In the above-described electronic device, however, the functions thereof are restricted based on the driving load conditions or vehicle status, such as being in motion/stopped. Therefore, the device cannot adapt to the capabilities of various users, which may differ in terms of speed and dexterity. That is, depending upon the degree of restriction of the functions, a skilled user may feel dissatisfied with the device's performance, and on the other hand, a user who is unfamiliar with the operation of the device may find it more than they can manage.

Moreover, since the restricted functions are predetermined according to the driving load conditions and the vehicle status, a user needs to perform a number of selecting operations while the vehicle is in motion in order to find out which functions are set as usable under the condition where the vehicle is in motion. Accordingly, the operation becomes troublesome.

Furthermore, if there is a change in a vehicle status, for example, the vehicle starts moving, in the middle of an operation, there may be a problem in that the functions selected by the user are disabled in the middle of an operation.

Moreover, in the above-mentioned menu display method, it is not presumed that the method would be used under special conditions, for example, in a vehicle in motion. Accordingly, a system using the method has a problem in that, when some of the frequently used functions are shifted to an upper tier, other functions are moved instead to a lower tier so that the user is required to perform more selecting operations to reach them, and the number of menu items displayed on a monitor increases.

The present invention was made in the light of these problems. An object of the present invention is to provide an information display system for a vehicle, which allows the user to perform efficient selection of operation menus under changing driving load conditions or vehicle status.

Another object of the present invention is to provide an information display system for a vehicle, which optimally constructs operation menus based upon a user's operation history so as to reduce the user's operation load.

An aspect of the present invention is a display system for a vehicle, which presents to a user a plurality of menu items respectively corresponding to functions of devices/equipment mounted on the vehicle by displaying an operation menu including some of the menu items on a screen of a display of the system, and allows the user to select one of the displayed menu items to perform the function thereof, the system comprising: an input unit to be operated by the user; an operatability judgment unit which judges user's operatability of the input unit; a storage unit which stores hierarchically structured first menu information, the first menu information comprising a plurality of the operation menus respectively registered in a plurality of tiers of the first menu information; and a display control unit which determines the operation menu to be displayed on the screen, based upon the operatability of the user judged by the operatability judgment unit, using the first menu information or a second menu information having a limited number of tiers as compared with the first menu information.

### BRIEF DESCRIPTION OF THE DRAWINGS

The invention will now be described with reference to the accompanying drawings wherein:

FIG. 1 is a block diagram showing a constitution of an information display system for a vehicle of a first embodiment according to the invention.

FIG. 2 is a flowchart illustrating a processing of a display control process of a first operation menu of the system in FIG. 1.

FIG. 3 shows chart data of an operation step number for each running condition of a vehicle used in the display control process of the first operation menu.

FIG. 4 is a flowchart illustrating a processing of a display control process of a second operation menu of the system in FIG. 1.

FIG. 5 is a flowchart illustrating a processing of a display control process of a third operation menu of the system in FIG. 1.

FIG. 6 shows chart data of an operation step number for each running condition of a vehicle used in the display control process of the third operation menu.

FIG. 7 is a flowchart illustrating a processing of a display control process of a fourth operation menu of the system in FIG. 1.

FIG. 8 is a flowchart illustrating a processing of a display control process of a fifth operation menu of the system in FIG. 1.

FIG. 9 is a block diagram showing constitution of an information display system for a vehicle of a second embodiment according to the invention.

FIG. 10 explains a menu structure of full menu information in the system in FIG. 9.

FIG. 11 illustrates an example of a menu structure of modified menu information in the system in FIG. 9.

FIG. 12 illustrates another example of the menu structure of the modified menu information in the system in FIG. 9.

FIG. 13 illustrates one example of a learning coefficient of process selection menu items and of integrated process selection menu items in the system in FIG. 9. The learning coefficient of a lower tier to the menu item is different depending upon the menu item.

FIG. 14 shows learning history information of each menu item and learning value information of the process selection menu items in FIG. 13.

FIG. 15 illustrates another example of a learning coefficient of process selection menu items and of integrated process selection menu items in the system in FIG. 9. The learning coefficient of a lower tier to the menu item is different depending upon the menu item.

FIG. 16 shows learning history information of each menu item and learning value information of the process selection menu items in FIG. 15.

FIG. 17 illustrates another example of learning coefficients of process selection menu items and of integrated process selection menu items in the system in FIG. 9. The learning coefficients of a lower tier to the menu item are different depending upon the menu item.

FIG. 18 shows learning history information of each menu item and learning value information of the process selection menu items in FIG. 17.

FIG. 19 illustrates another example of learning coefficients of process selection menu items and of integrated process selection menu items in the system in FIG. 9. The learning coefficients of a lower tier to the menu item are different depending upon the menu item.

FIG. 20 shows the learning history information of each menu item and the learning value information of the process selection menu items changing over time of the system in FIG. 9.

FIG. 21 is a graph illustrating a change of the learning coefficient of the system In FIG. 9 over time.

FIG. 22 is a flow chart illustrating a processing of a learning process and a learning coefficient setting process in a menu learning/structure construction unit of the system in FIG. 9.

### DETAILED DESCRIPTION OF THE PREFFERED EMBODIMENT

Embodiments of the present invention will be explained below with reference to the drawings, wherein like members are designated by like reference characters.

[Constitution of Information Display System S1]

An information display system S1 of a first embodiment according to the present invention is mounted on a vehicle, for example, an automobile and displays various information to a user such as a vehicle driver.

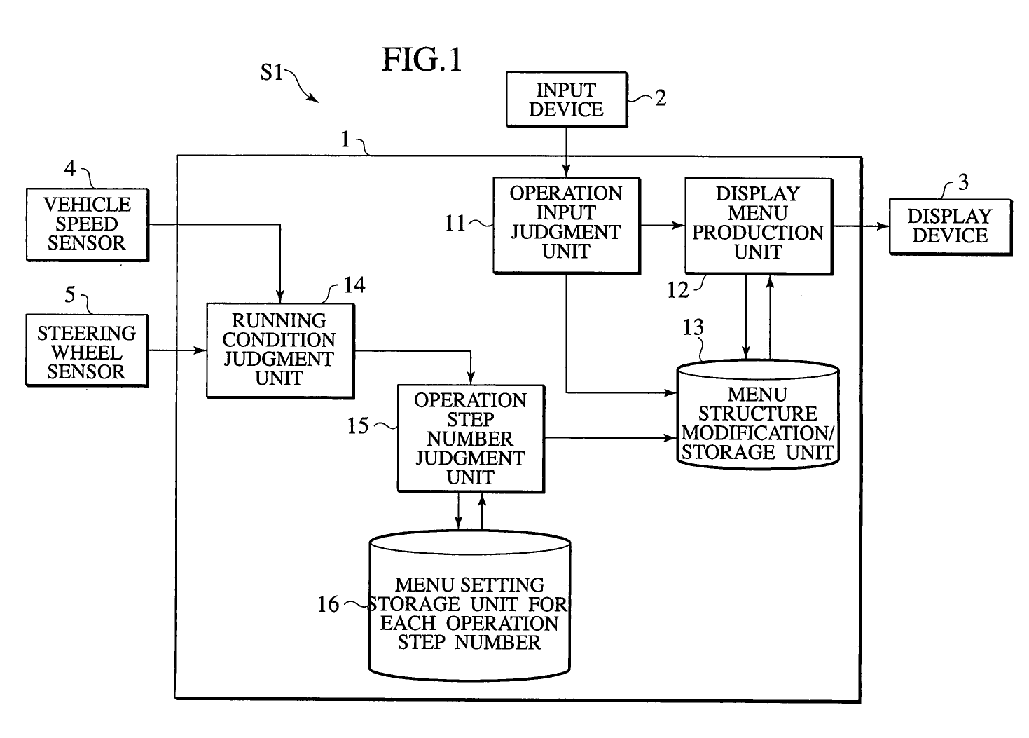

The information display system S1, as shown in FIG. 1, includes a display controller 1 of a vehicle-mounted computer where information to be displayed is managed by the display controller 1 and a display device 3 is controlled according to commands input into an input device 2 by the display controller 1.

The display controller 1, a vehicle speed sensor 4 and a steering wheel sensor 5 are accommodated in an instrument panel, and the input device 2 is disposed in a place where the driver is able to operate it, and the display device 3 is set to be located within the driver's sight.

The input device 2 is equipped with a plurality of buttons, jog dials or joy sticks, and sends operation input signals that indicate operation commands to the display controller 1 corresponding to the user's operation thereof.

The vehicle speed sensor 4 is, for example, a sensor for the rotation speed of the wheels of the vehicle and sends a value corresponding to vehicle speed as a vehicle speed signal to the display controller 1.

The display device 3 functions as information display unit displaying various information to the user. The display device 3 is, for example, a liquid-crystal display on which a navigation screen including map data and the like is displayed, as well as operation menus being displayed to enable a user to select functions of vehicle mounted apparatuses, such as a car navigation system, an in-car audio, a communication apparatus. Menu items of the operation menus to be displayed on one screen at one time are limited to, for example, 4 items.

The steering wheel sensor 5 is, for example, a steering angle sensor, and detects a steering operation of a steering wheel by the user, thereafter outputting a value in accordance with a steering angle of the steering wheel as a steering wheel operation signal to the display controller 1.

The display controller 1 consists of a CPU (Central Processing Unit), a memory and so on, and carries out an information display program stored in the memory with the CPU. Namely, the display controller 1 includes an operation input judgment unit 11 and a display menu production unit 12 as functions to be carried out by the information display program, and also a menu structure modification/storage unit 13 as a function to be carried out by the memory. Further, the display controller 1 includes a vehicle running condition judgment unit 14, an operation step number judgment unit 15, and a menu setting storage unit 16 for each operation step number.

The operation input judgment unit 11 judges operation commands of the user based upon an operation input signal sent from the input device 2. In a case where the operation input judgment unit 11 judges that the operation commands is the one which changes the structure of the operation menu, the operation input judgment unit 11 sends operation input judgment information showing the operation commands to the menu structure modification/storage unit 13. Also in a case where the operation input judgment unit 11 judges that the operation commands is the one which shifts the operation menu to an upper tier or a lower tier, the operation input judgment unit 11 sends the operation input judgment information showing the operation commands to the display menu production unit 12.

Moreover, in a case where the operation input judgment unit 11 judges that the operation commands carry out the functions of various devices (not shown) mounted on a vehicle, the operation input judgment unit 11 sends a function execution command to these devices.

The menu structure modification/storage unit 13 includes, for example, an EEPROM (Electronically Erasable and Programmable Read Only memory) and the like, wherein full menu information, showing a full menu in which contents of the operation menus hierarchically constructed as a tree structure, is stored, as well as modified menu information, with a limited number of tiers (number of operation steps) as compared with the full menu information, is stored.

The full menu information has a six-tier structure in which a first tier as the uppermost tier consists of a route menu, and a sixth tier as the lowermost tier includes function execution menu items. The first to fifth tiers are function selection menu items for selecting function execution menu items of the sixth tier. Also this full menu information is constructed to display four menu items as the operation menu within one screen. However, function execution menu items may be set not only in the sixth tier, but also may be set in any of the second to fifth tiers as the lowermost tier.

In the following explanation, the menu items for both function selection and function execution are named collectively as “menu item”.

The modified menu information consists of a plurality of pieces of menu information with differing numbers of tiers. For instance, as in the system 1, the full menu information has the first to sixth tiers, while the modified menu information has only the first to third tiers.

That is, in the full menu information the function execution menu items cannot be performed until the operation has reached the sixth tier, and on the other hand, in the modified menu information, the function execution menu items can be performed upon reaching the third tier. Therefore, in this case, the selection of menu items by the user can be managed in only 3 selection operations.

Moreover, operation step number limit information for limiting the operation step number is sent to a menu structure modification/storage unit 13 from an operation step number judgment unit 15. When the menu structure modification/storage unit 13 receives the operation step number limit information, it makes the full menu information into the modified menu information.

That is, the menu structure modification/storage unit 13 functions as a menu information production unit by producing modified menu information based on full menu information.

The display menu production unit 12 recognizes the operation menu to be displayed on the display device 3 based upon operation input judgment information sent from the operation input judgment unit 11, thereby producing the display data for displaying the operation menu and then sends it to the display device 3. Meanwhile, the display menu production unit 12 displays the operation menu in the display device 3 by using the full menu information or the modified menu information according to the operation step number judged by the operation step number judgment unit 15.

When the running condition judgment unit 14 receives a vehicle speed signal from the vehicle speed sensor 4, the running condition judgment unit 14 judges the vehicle as being in motion based on the vehicle speed signal and sends running condition information, which shows a state of vehicle as being in motion or stopped, together with a steering wheel operation signal sent from the steering wheel sensor 5 to the operation step number judgment unit 15.

The operation step number judgment unit 15 judges the number of the operation steps in accordance with the running condition of the vehicle based on the running condition information and the steering wheel operation signal sent from the running condition judgment unit 14, by referring to the operation step number chart data for each running condition that is stored in the menu setting storage unit 16 for each operation step number and then sends the of the number of operation steps to the menu structure modification/storage unit 13. Thereby, the number of the operation steps that can be operated by the user is limited based on the current running condition of the vehicle.

The operation step number chart data that is stored in the menu setting storage unit 16 for each operation step includes a vehicle speed, a running condition (the state of vehicle as being in motion or stopped), an amount of steering wheel operation and a number of the operation steps, which are shown related to each other. With this operation step number chart data for each running condition, the operation step number judgment unit 15 recognizes the number of the operation steps that is permitted to be operated by the user in accordance with a predetermined running condition and the steering wheel operation signal.

[The Operation Menu Display Control Process by the Information Display System S1]

Next, it will be explained how the first to fifth operation menu displays are controlled and processed by the information display system S1 that is constituted as described above.

[The First Operation Menu Display Control Process]

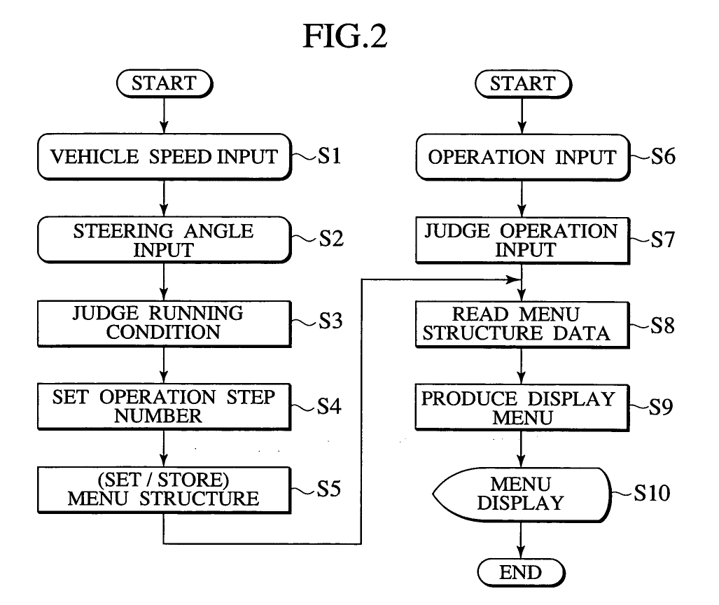

A first operation menu display control process, as shown in FIG. 2, consists of the following steps. In step S1, when the system S1 is in operation sue to the switching on of an ignition switch of a vehicle, the vehicle speed signal is input every predetermined period from the vehicle speed sensor 4. In step S2, the steering wheel operation signal is input from the steering wheel sensor 5. In step S3, the running condition of the vehicle is judged based upon these signals by the running condition judgment unit 14 and then the running condition judgment information is sent to the operation step number judgment unit 15.

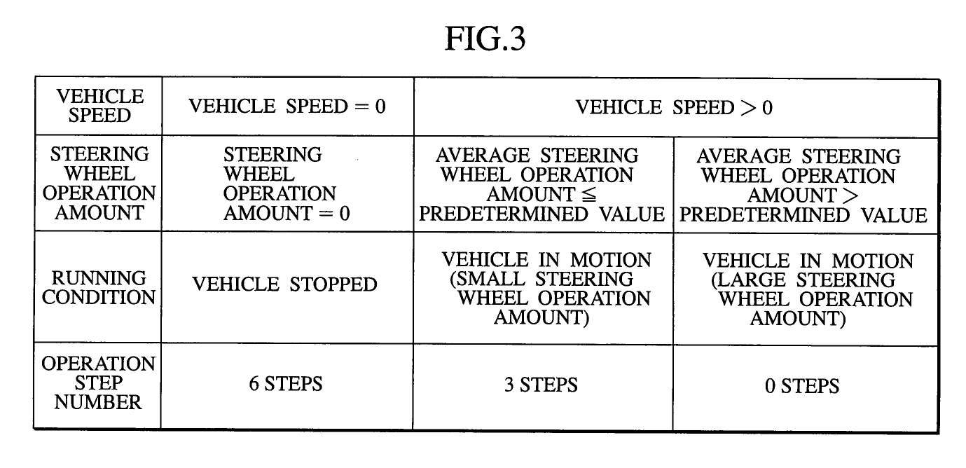

The operation step number judgment unit 15 receives the running condition judgment information, sets the number of the operation steps permitted by the system based on the operation step number chart data (FIG. 3) for each running condition in the menu setting/storage unit 16 for each operation step number, and sends this set operation step number to the menu structure modification/storage unit 13 as limit information for limiting the number of operation steps. When the vehicle speed is ‘0’, the running condition is that the vehicle is stopped and the amount of steering wheel operation is ‘0’, the operation step number will be set as 6 steps, which permits performing an operation using the full menu information. Moreover, when the vehicle speed is greater than ‘0’, the running condition is that the vehicle is in motion and if an average amount of steering wheel operation is less than a predetermined value, the operation step number will be set as 3 steps, which permits performing an operation using the modified menu information.

And furthermore, when the vehicle speed is larger than ‘0’, the running condition is that the vehicle is in motion and if the average amount of steering wheel operation is more than a predetermined value, the operation step number will be set as 0 steps, which means that operations related to the operation menu is prohibited.

Namely, in step S4, the running condition judgment unit 14, the operation step number judgment unit 15 and the menu setting storage unit 16 for each operation number function together as a driving load judgment unit, which sets the limit operation step number permitted by the system as 6 steps where the full menu information can be applied, judging that the user has the highest operation capability when the vehicle is stopped and as 3 steps in a case where an amount of steering wheel operation when the vehicle is in motion is less than a predetermined value, judging that the user has less operation capability than when the vehicle is stopped, and further as 0 steps in a case where an amount of steering wheel operation is more than a predetermined value, judging that the user has the further lower operation capability.

The menu structure modification/storage unit 13 recognizes the menu information that will be used based upon the limit information of the operation step number sent from step S4. Thereby, in step S5, the menu structure modification/storage unit 13 sets and stores the menu structure for the operation menu display, and then the process proceeds to step S8.

On the other hand, in step S6, when the input device 2 is operated, the operation input signal is input to the operation input judgment unit 11. And in step S7, the operation input judgment unit 11 judges the operation commands by the operation input signal and sends the operation input judgment information to the display menu production unit 12.

In step S8, the display menu production unit 12 reads on the menu information the menu structure of which is stored in step S5. That is, the display menu production unit 12 reads on the full menu information when the number of the operation steps is set as 6 steps in step S4, reads on the modified menu information when the number of the operation steps is set as 3 steps, and does not execute the process to read on the menu information when the operation is prohibited.

And then, in step S9, the display menu production unit 12 produces the display menu which shows 4 menu items within one screen of the monitor, based on the read-on menu information. In step S10, the display menu production unit 12 controls the display device 3, to display the operation menu.

As in the controller 1 such first menu operation display control process is performed, in a case where all the functions of the vehicle-mounted device are possible when the vehicle is stopped. On the other hand, since it is necessary to prohibit a part of the functions when the vehicle is in motion, the operation menu is displayed using the modified menu information. Consequently, even if the operation starts while the vehicle is in motion and the operation proceeds from the first tier to a lower tier, the user can execute the functions as he/she wishes.

Furthermore, according to the display controller 1, the display menu production unit 12, the menu structure modification/storage unit 13 and the operation step number judgment unit 15 function together as a display control unit, which judges the operation capability of the user when the vehicle is in motion and stopped and then, based upon the judged operation capability of the user, determines the timing for altering the number of menu tiers of the menu information to the number of the menu tiers where the user is able to operate. Therefore, an efficient operation of the operation menu can be performed even if the driving load of the vehicle changes.

In addition, according to the display controller 1, if the amount of steering wheel operation becomes larger, the operation step number is set as 0, thereby temporarily prohibiting the operation, so that compelling the operation when a driving load of the vehicle is heavy is avoided.

[The Second Operation Menu Display Control Process]

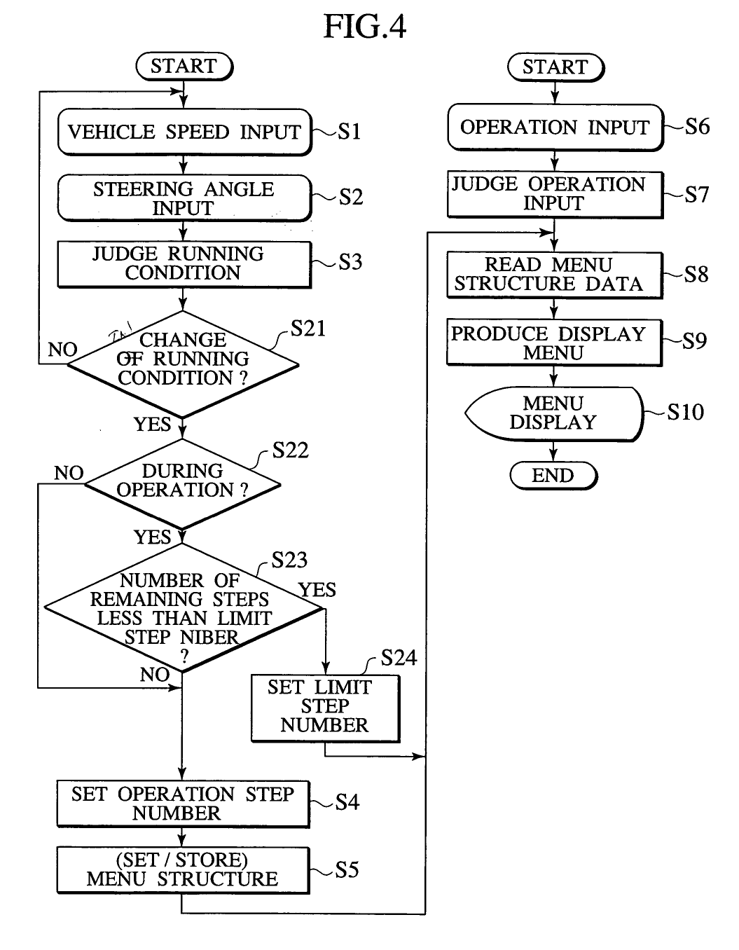

Next, A second menu display control process executed by the above-mentioned information display system S1 will be explained with reference to the flowchart shown in FIG. 4. However, the same processes herein as in the first menu display control process are referred to with the same step numbers thereof, and detailed explanations of the same step numbers are omitted.

In the second operation menu display control process, in step S21, after the running condition judgment information and the steering wheel operation signal are input to the operation step number judgment unit 15 in step S3, the operation step number judgment unit 15 judges whether or not the current running condition differs from the running condition of the previous judgment of the operation step number judgment unit 15.

In step S22, if it is judged that there is no change in the running condition, the process goes back to step S1, wherein the operation step number set by the prior operation display menu control process is not modified. On the other hand, if it is judged that there has been a change thereof, the operation step number judgment unit 15 judges at that moment, whether or not the operation menu displayed on the display device 3 is prompting the user to operate the operation menu, and judges whether or not the user is in the middle of an operation.

When the operation step number judgment unit 15 judges that the user is not in the middle of an operation, the process goes forward to step S4. In step S4, the operation step number judgment unit 15 sets a permitted operation step number, referring to the operation step number chart data for each running condition, based on the running condition and the amount of steering wheel operation, and then, the menu information used by the display menu production unit 12 is recognized by the menu structure modification/storage unit 13, and thus the process goes to step S8.

On the other hand, in step S23, when it is judged in step S22 that the user is in the middle of an operation, the operation step number judgment unit 15 judges whether or not the remaining operation step number until any of the function execution menu items is selected is less than a limit step number, based upon the menu steps displayed at that moment in the display device 3. The limit step number means the operation step number permitted when the vehicle is in motion or stopped, which is a predetermined value.

The limit step number is set as, for example, 3 steps, when it is judged that the running condition has changed from the vehicle being stopped to the vehicle being in motion in step S21, and then in step 23 this 3 step limit is compared with the above-mentioned remaining operation step number. In step S24, if the remaining operation step number is judged as being more than 3 steps, the remaining operation is not limited and the process goes to step S4. On the other hand, if the remaining operation step number is judged as being less than 3 steps, then the limit number of the steps, as the system-permitted operation step number, is set and the process proceeds to step S8.

In the next step S8, in accordance with the operation step number that is set in step S4 or S24, the modified menu information or the full menu information is read from the menu structure modification/storage unit 13. Next, in step S9 and S10, the display menu production unit 12 displays the operation menu by using the modified menu information or the full menu information.

In the display controller 1 such a second menu operation display control process is executed. Thereby, in a case where when the vehicle is in a vehicle stopped state, the operation of the operation menu with the full menu information starts and the running condition of the vehicle changes before the operation ends, and when the remaining operation step number is more than the limit step number, the permitted step number will be set as the step number according to the operation step number chart data for each running condition. Also, in a case where the remaining operation step number is less than the limit step number, the permitted step number will be set as the same as this limit step number. As a result, the full menu information is shifted to the modified menu information at an optimal timing. That means, even if the running condition changes from a vehicle stopped state to a vehicle in motion state, the operation menu of the full menu information can be continuously displayed, so that the prohibition of the functions which the user desires to use can be avoided when the running condition is changed.

Also in the display controller 1, in a case where the operation of the operation menu using the modified menu information, the operation step number of which is limited, starts when an amount of steering wheel operation is small and then the steering wheel operation amount becomes larger before the operation ends, if the remaining operation step number is one step less than the limit step number, it is possible to continue operation for one operation step only. This prevents the driver from feeling annoyed by the prohibition of the one remaining operation step.

Namely according to the display controller 1, even if the amount of steering wheel operation increases from small to large, the operation can be continued without limiting the permitted step number to 0.

[The Third Operation Menu Display Control Process]

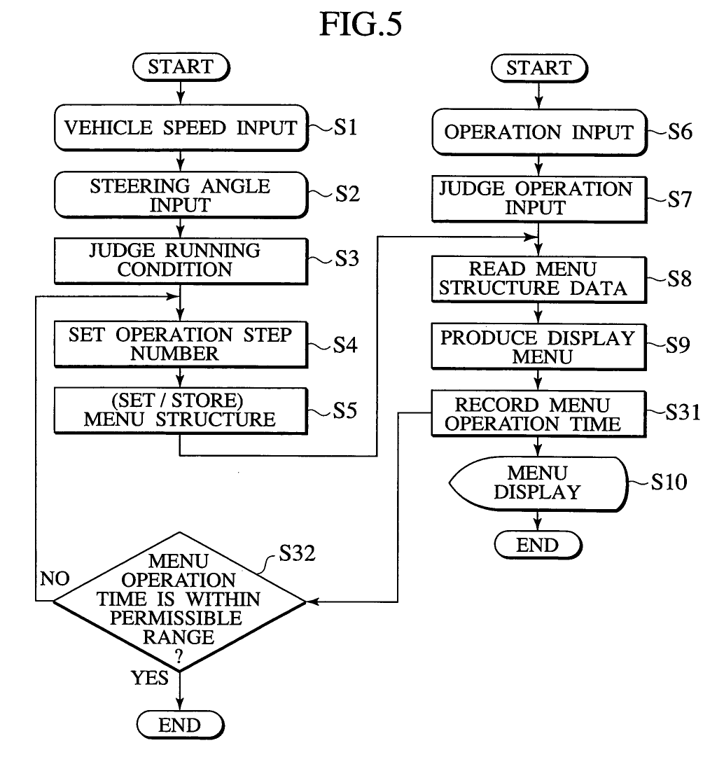

Next, a third menu display control process performed by the above-mentioned information display system S1 will be explained referring to the flow chart shown in FIG. 5. The same processes herein as in the first and second menu display control processes are referred to with the same step numbers, and detailed explanations for the same step numbers are omitted.

This third operation menu display control process proceeds with the following steps. In step S1-S5, the third operation menu display control process sets the operation step number based on the running condition and the amount of steering wheel operation, thereby displaying the operation menu by using the menu information corresponding to the set operation step number, and at the same time, the operation input judgment unit 11 monitors a menu operation time of from when a menu is displayed until the user selects the menu. In step S31, this menu operation time is recorded. Such process is executed every time when the operation of the input device 2 is performed, so that a menu operation time specific to the user can be obtained.

Next, in step 32, the operation step number judgment unit 15 judges whether or not the menu operation time recorded in the operation input judgment unit 11 is within the permissible range. As for the permissible time, for example, 10 seconds is set when a vehicle is in motion and 30 seconds is set when a vehicle is stopped as the time of from when the operation menu is displayed to when the input device 2 is operated.

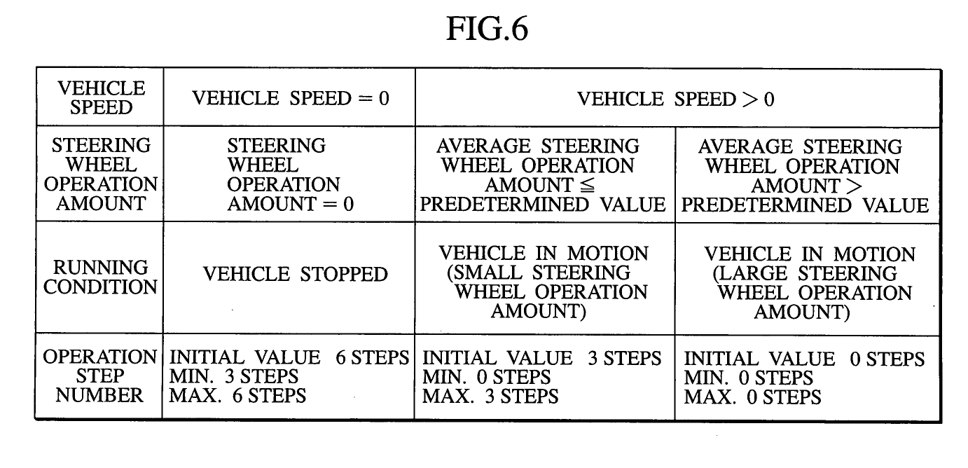

When the operation step number judgment unit 15 judges that the menu operation time is within the permissible range, the process ends, based upon judging that the operation menu with a tier number favorable to the user is displayed. On the other hand, when the menu operation time is more than the permissible range, the operation step number judgment unit 15 judges that the operation menu with a tier number unfavorable to the user is displayed, and then the process returns to step S4. Instep S4, the operation step number judgment unit 15 resets the operation step number, referring to the operation step number chart data for each running condition as shown in FIG. 6 stored in the menu setting/storage unit 16 for each operation step number.

Then, when the operation step number judgment unit 15 sets the operation step number after step S3, the operation step number judgment unit 15 adopts the operation step number registered as an initial value, based on the vehicle speed, the amount of steering wheel operation and the running condition, and on the other hand, when the operation step number is reset after step S23, the operation step number increases or decreases in a range of from the minimum operation step number to the maximum operation step number registered corresponding to the vehicle speed, the amount of steering wheel operation and the running condition.

Herein the full menu information corresponding to the maximum value of the operation step number and the modified menu information corresponding to the minimum value thereof are stored in the menu structure modification/storage unit 13 as the information for a vehicle stopped state, as well as the menu information corresponding to an initial value, the maximum value, and two steps or one step less than the minimum value of the operation step number is stored as the menu information for when the vehicle is in motion.

Accordingly, in the display menu production unit 12, in the event that the operation step number is limited by the operation step number judgment unit 15, the menu information corresponding to each limit value can be used in the display menu production unit 12.

In the display controller 1, the operation step number can be changed based on the menu operation time by performing such third operation menu display control process, and thereby the operation menu can be displayed by using the menu information of an optimal operation step number in accordance with the user's operation capability. That is, the operation input judgment unit 11, the operation step number judgment unit 15 and the menu setting/storage unit 16 for each operation step number function together as the user's operation capability judgment unit.

Also, according to the display controller 1, each of the operation step numbers when the full menu information is used and when the modified menu information is used can be independently modified based upon the menu operation time. For example, the operation step number can be set corresponding to an operation capability during temporary vehicle stopped such as waiting for a change of a traffic signal.

[The Fourth Operation Menu Display Control Process]

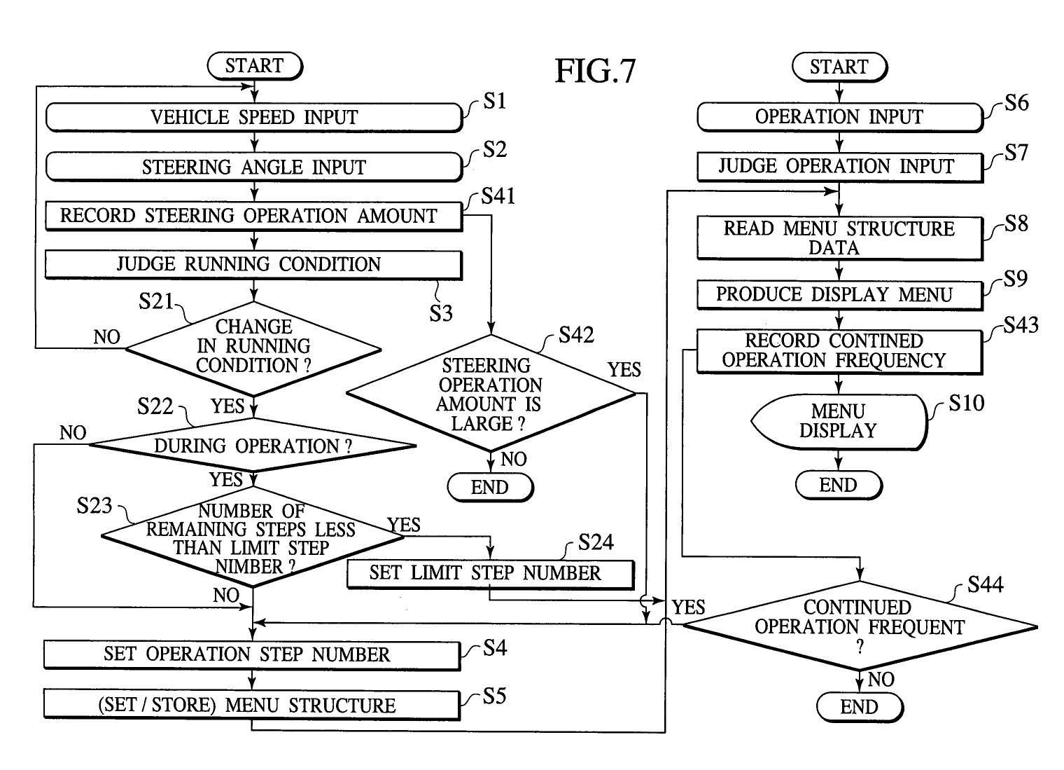

Next, a fourth menu display control process performed by the above-mentioned information display system S1 will be explained, referring to the flow chart shown in FIG. 7. The same processes herein as the first and second menu display control processes are referred to as the same step number, and the detailed explanation for the same step number will be omitted.

In the fourth operation menu display control process, in step S41 following the process of step S1 and S2, the running condition judgment unit 14 records the amount of steering wheel operation detected in the step S2, and in step S42, judges whether or not the amount of steering wheel operation is larger than a predetermined value. When the amount of steering wheel operation is larger than the predetermined value, the permitted operation step number is set as modified to a smaller number in step S4, and then the process moves to step S5, step S8 and step S9. When the amount of steering wheel operation is less than the predetermined value, the process ends without altering the set operation step number.

In the display controller 1, after the display data is produced in order to display the operation menu in step S9, in step S43, the frequency of continuous operation (continued operation frequency) is updated and recorded. The display controller 1 displays the operation menu in step S10, and in step S44, also judges whether or not the continued operation frequency is higher than a predetermined value. When the display controller 1 judges that the continued operation frequency is higher than the predetermined value, the permitted operation step number is set to be increased in step S4, while when the continued operation frequency is lower than the predetermined value, the process ends without changing the operation step number.

By performing such fourth operation menu display control process in the display controller 1, in a case where the vehicle begins moving when the operation menu using full menu information is allowed to be operated while a vehicle is stopped, if the remaining operation step number is less than the limit step number, continued operation is allowed (step S23 and step S24). Further, if the frequency of continuous operation is high, the operation step number permitted when the vehicle is in motion can be increased. Therefore, according to the display controller 1, when the amount of steering wheel operation is large, the permitted operation step number is decreased, and also when the continued operation frequency is high, the permitted operation step number will be increased. Thus, when a user with a high operation capability operates the system, the operation step number is increased, and on the other hand, when a user with a low operation capability operates the system, the operation step number is decreased.

However, when the operation step number is thus increased according to the amount of steering wheel operation and the continued operation frequency, the operation menu is displayed by the display menu production unit 12 by using the menu information corresponding to each operation step number as in the third menu display control process.

[The Fifth Operation Menu Display Control Process]

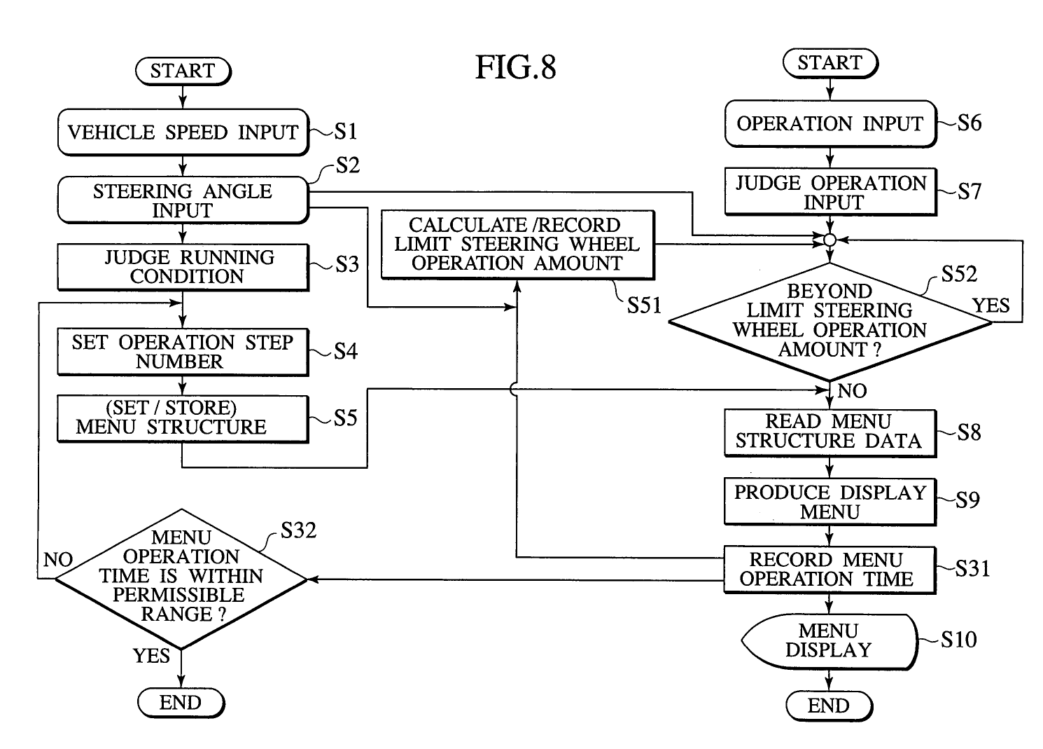

To the next, a fifth menu display control process performed by the above-mentioned information display system S1 will be explained, referring to the flow chart shown in FIG. 8.

The same processes herein as in the above-mentioned menu display control processes are referred to with the same step numbers, and detailed explanation for the same step numbers will be omitted.

In the information display system S1, after the display data is produced in the step S9, the menu operation time is recorded as above-described, and the running condition judgment unit 14 calculates and records the limit steering wheel operation amount based on the menu operation time history in step S51 following step S1 and step S2.

That is, then the process proceeds to step S52. The running condition judgment unit 14 detects an amount of steering wheel operation when an average menu operation time is over the predetermined time, by referring to the menu operation time history, and this detected amount of steering wheel operation is defined as the limit steering wheel operation amount, which means that the user is tied up to driving and therefore can not perform the menu operation at that moment.

And the display controller 1 judges the operation commands in step 6 and step 7, and then in step 52, judges whether or not the amount of steering wheel operation is over the limit steering wheel operation amount in the event of displaying the operation menu. When the amount of steering wheel operation is over the limit steering wheel operation amounts, the operation menu is not displayed. On the other hand, only when the amount of steering wheel operation is less than the limit steering wheel operation amount, the processes in step S8-step S10 will be executed so that the operation menu in accordance with the operation commands is displayed.

Thus, according to the fifth operation menu display control process, when the operation menu during vehicle in motion is being operated, the fifth operation menu display control process records the average time of the menu operation time recorded in step S31 and the history of the steering wheel operation amount, thereby to calculate the limit steering wheel operation amount when the average time of the menu operation time is over a predetermined time, and stops displaying the operation menu when the amount of steering wheel operation is over the limit steering wheel operation amount.

As a result, an optimum step number can be set in consideration of an influence of the menu operation during vehicle in motion to the steering wheel operation.

[Constitution of Information Display System S2]

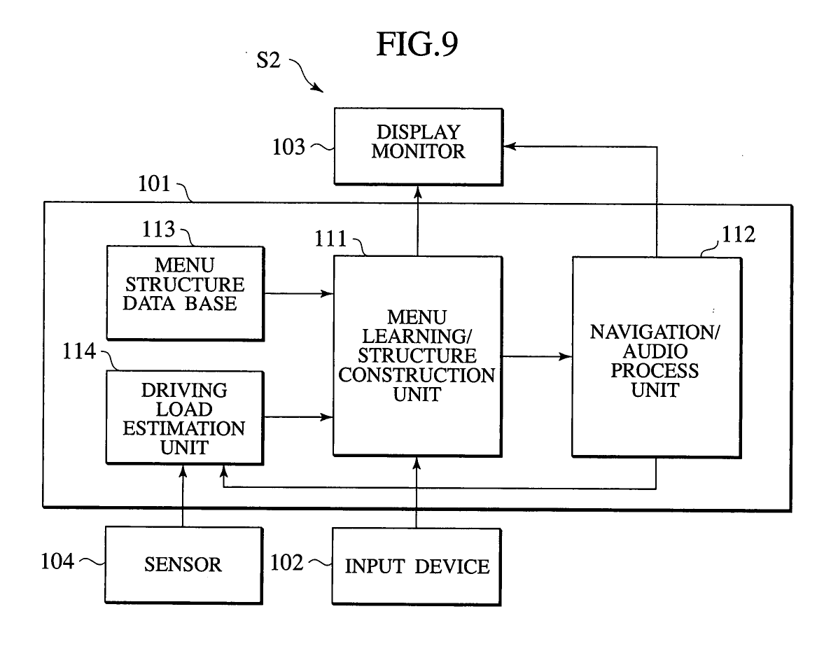

An information display system S2 for a vehicle of a second embodiment according to the invention is, in the same way as the information display system S1, mounted on a vehicle such as an automobile and displays various information to users like a vehicle driver. In the system S2, as shown in FIG. 9, in a display controller 101, display data for menu display are read out from a menu structure data base 113, based upon a load to the driver estimated by a driving load estimation unit 114 and an operation input content to an input device 102. And information generated in an operation menu and a navigation/audio process unit 112 is displayed in a display monitor 103 by a menu structure learning/construction unit 111.

In the information display system S2, the display monitor 103 is placed at a position within a user'sight, and the input device 102 is placed where the user can operate it. The driving load estimation unit 114, the menu structure data base 113 and a menu structure learning/construction unit 111 are received within an instrument panel. Also in the system S2, other than the menu structure learning/construction unit 111 and the navigation/audio process unit 112, a communication device equipped with functions sending and receiving emails, as well as telephone communications may be connected. Thereby information generated in the communication device and the like in addition to the navigation/audio process unit 112 can be displayed in the display monitor 103.

The driving load estimation unit 114 estimates a load to a vehicle driver as a driving load and then sends the estimated load to the menu structure learning/construction unit 111 as the driving load information. Namely the driving load estimation unit 114 obtains update information with regard to roads such as the kind of the road, the in motion lane of the vehicle and so on from the navigation/audio process unit 112, as well as information with regard to a driving operation of the vehicle such as a vehicle speed, steering, acceleration, and braking thereof from various sensors 104, thereby to estimate the driving load.

The input device 102 is equipped with, for example, a push button, a jog dial, and a joy stick, and sends an operation input signal showing operation commands to the menu structure learning/construction unit 111 in the display controller 101 in accordance with an operation thereof by the driver. The operation input signal includes a signal changing an operation menu display displayed in a display monitor 103 and a signal executing a process corresponding to menu items contained in the operation menu display.

The menu structure data base 113 includes an EEPROM and the like, and stores full menu information showing a full menu where contents of the operation menu are hierarchically constructed in a tree structure and an modified menu information different in the number of tiers from the full menu information. The modified menu information is produced based upon the full menu information by the menu structure learning/construction unit 111 and is registered in the menu structure data base 113.

Also the menu structure data base 113 stores function information of each menu item and operation history information showing selection operation times of each menu item as information in common with the full menu information and the modified menu information. Further, the menu structure data base 113 stores transfer relation information showing a transfer relation of each operation menu from the uppermost tier to the lowermost tier for each of the full menu information and the modified menu information. The operation history information is produced based upon the commands of the input device 102 by the menu structure learning/construction unit 111 and is registered in the menu structure data base 113.

Further, the menu structure database 113 stores a learning value information summing, for each process selection menu item, operation times of each menu item located in a tier lower than a tier of the process selection menu items, and a learning coefficient determining a learning speed of each menu item located in a tier lower than a tier of the process selection menu items. These learning value information and the learning coefficient are produced in a learning process and a learning coefficient setting process in the menu structure learning/construction unit 111 described later and are registered in the menu structure data base unit 113.

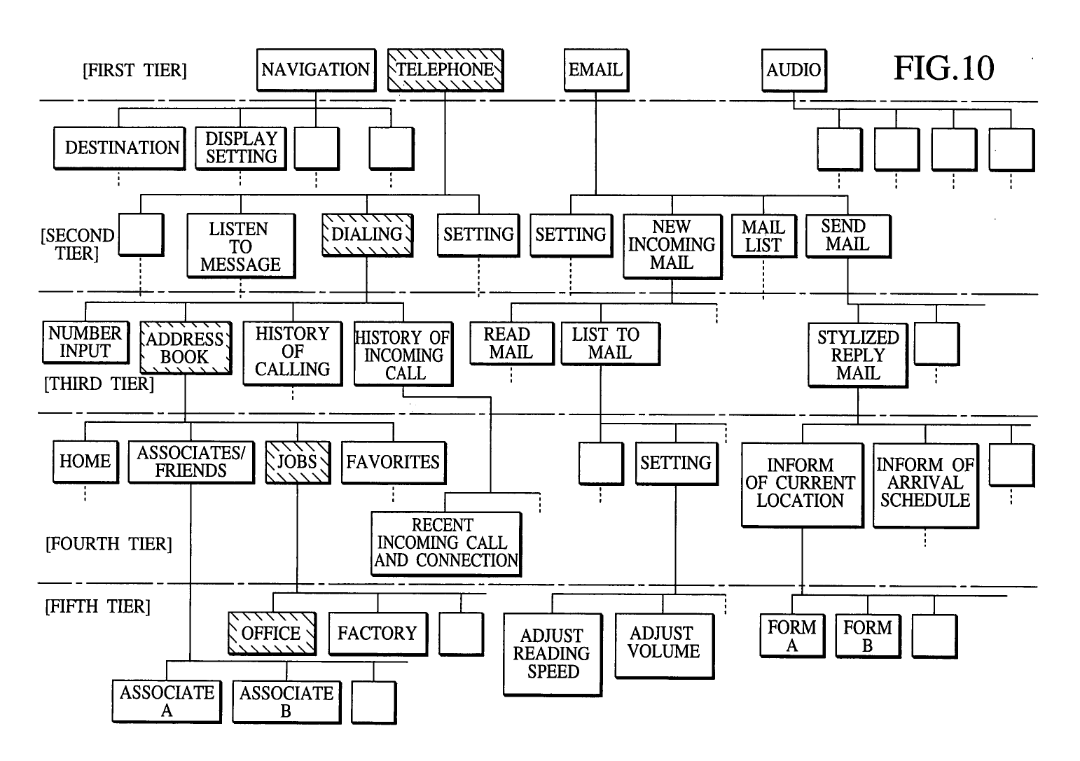

In the information display system S2, the full menu information includes, for example, five-tier structure shown in FIG. 10. A first tier as the uppermost tier thereof is a main menu and a fifth tier as the lowermost tier thereof consists of process execution menu items in the fifth tier that determine the process execution. Also the full menu information is constituted as to display four menu items as the operation menu within one screen by one screen. However, the process execution menu items may be set in not only the fifth tier but also in any of a second tier-a fourth tier as the lowermost tier.

And the modified menu information is constructed such that the number of tiers thereof is limited compared with the full menu information. The process execution menu items and process selection menu items in each tier of the modified menu information are determined by the menu structure learning/construction unit 111. However, with regard to the full menu information, modification of the menu items by the menu structure learning/construction unit 111 is prohibited.

Further, menu item display data are stored in the menu structure data base 113 for displaying each menu item corresponding to each menu item.

The menu structure learning/construction unit 111 utilizes the above-described various information registered in the menu structure data base 113, as well as carries out the following various processes based upon a driving load estimated in the driving load estimation unit 114 and the commands of the input device 102.

[Process Contents in the Menu Structure Learning/Construction Unit 111]

[Operation Menu Display Process]

When the menu structure learning/construction unit 111 receives a driving load information from the driving load estimation unit 114 and an operation input signal from the input device 102, the menu structure learning/construction unit 111 reads out the menu item display data from the menu structure data base 113 with reference to the full menu information and the modified menu information stored in the menu structure data base 113, and then performs a menu display thereof in the display monitor 103.

In a case where the menu structure learning/construction unit 111 receives the operation input signal from the input device 102 at a state where the operation menu having a plurality of the menu items menu items is displayed, the menu structure learning/construction unit 111 carries out a process of displaying with reference to the transfer relation information the operation menus located in a tier lower than a tier where the selected menu items are located. And in a case where the menu structure learning/construction unit 111 receives the operation input signal from the input device 102 at a state where the operation menu having a plurality of the process execution menu items is displayed, the menu structure learning/construction unit 111 carries out a process by outputting a process execution command in accordance with the function information with reference to the function information corresponding to the selected process execution menu items to the navigation/audio process unit 112.

In detail, as shown in FIG. 10, as “navigation”, “telephone”, “email”, and “audio” are set as the menu items of the main menu in the first tier, the menu structure learning/construction unit 111 reads out and displays menu item display data for displaying buttons for navigation, telephone, email, and audio in a menu display area on a screen. For example, when the process selection menu item of “telephone” hatched in FIG. 10 is selected, the operation menu including four process selection menu items of the second tier is displayed. When the process selection menu item of “dialing” is selected in the second tier, the operation menu including four process selection menu items in the third tier is displayed. When the process selection menu item of “address book” is selected in the third tier, the operation menu including four process selection menu items in the fourth tier is displayed. When the process selection menu item of “job” is selected in the fourth tier, the operation menu including four process execution menu items in the fifth tier is displayed. When the menu structure learning/construction unit 111 recognizes that the process execution menu item of “office” is selected in the fifth tier, the menu structure learning/construction unit 111 sends to an outside communication device a command for executing a process of dialing an office.

Further, the menu structure learning/construction unit 111 displays an modified menu information corresponding to a driving load estimated by the driving load estimation unit 114 instead of the full menu information showing the above-described full menu. In this embodiment, for example, only the full menu is usable on a vehicle stop, and only the modified menu information is usable on a vehicle in motion.

[Selection Process for Menu Item]

And the menu structure learning/construction unit 111 executes selection process of the menu items for selecting four menu items located in each tier of the modified menu. Namely, the menu structure learning/construction unit 111 limits the number of tiers of the modified menu information corresponding to the driving load compared with the full menu, and selects, based upon a learning value information, the menu items displayed at each tier limited the selection process for the menu items includes a process for selecting the process selection menu items that are used frequently from the learning value information, a process for producing integrated menu items integrating a plurality of different functions, and further a process for subdividing the process selection menu items that are used frequently, to be located in an upper tier.

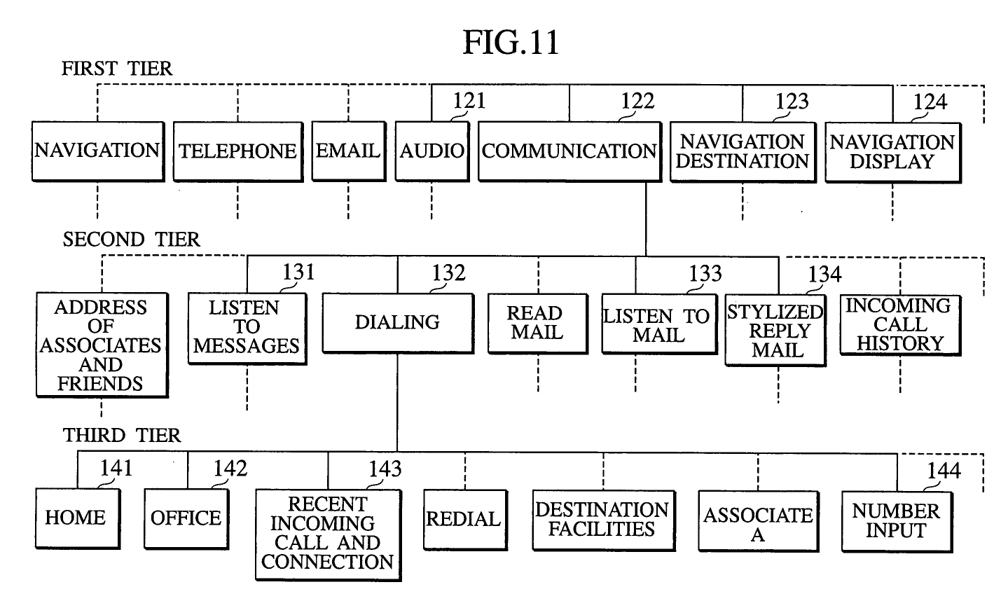

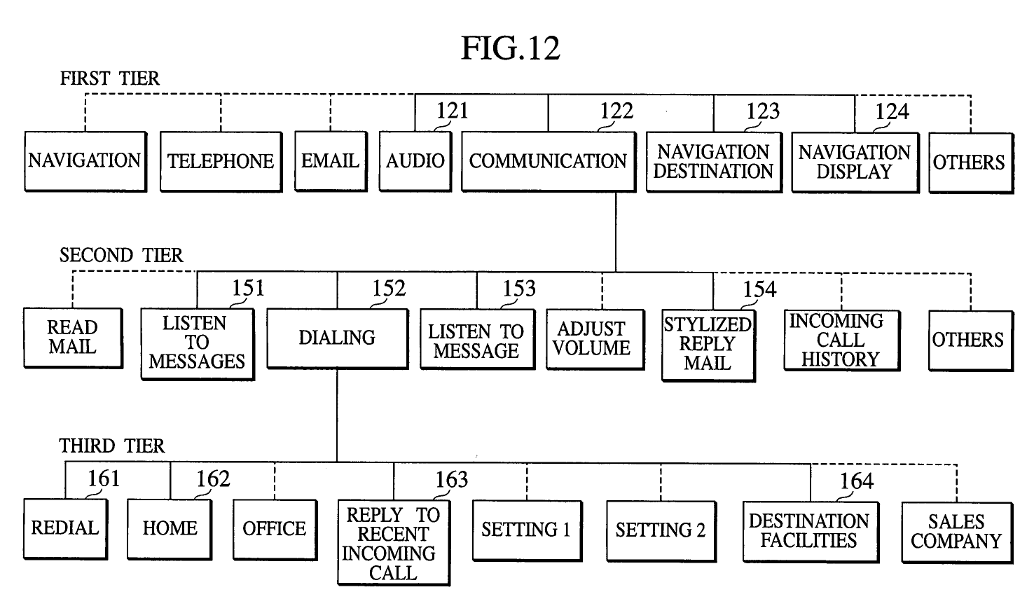

Thereby, the menu structure learning/construction unit 111 alters the full menu shown in FIG. 10 to the modified menu shown in FIGS. 11 and 12. The modified menu information shown in FIGS. 11 and 12 the number of tiers of which is limited by the menu structure learning/construction unit 111 for reducing a driving load to the driver on vehicle in motion has a three-tier structure to the full menu with the five-tier structure.

In detail, in the modified menu information shown in FIGS. 11 and 12, the process selection menu item 121 for selecting an audio function, an integrated process selection menu item 122 for selecting different kinds of functions such as telephone and email, the process selection menu item 123 for displaying a destination of a navigation function in the navigation/audio process unit 112, and the process selection menu item 124 for displaying a map screen of the navigation function in the navigation/audio process unit 112 are selected as the first tier. Herein, the process selection menu items 121, 123, and 124, as well as the integrated process selection menu item 122 are the menu items that are judged by the menu structure learning/construction unit 111 as being used frequently from the learning value information.

And since frequency of use of “navigation” located in the first tier of the full menu in FIG. 10 as the process selection menu item for selecting the navigation function is high, the menu item “navigation” is subdivided into the process selection menu items 123 and 124 that have originally been in the second tier in the full menu as the menu items “destination” and “display”, which are shifted to the first tier.

Further, in the modified menu in FIGS. 11 and 12, the integrated process selection menu item 122 of “communication” that does not exist in the full menu in FIG. 10 is produced by the menu structure learning/construction unit 111 and is set in the first tier. In the lower tier to the integrated process selection menu item 122, the menu item for selecting an email function and a telephone function is set, as shown in FIG. 11, as transition relation information with regard to the modified menu information.

In detail, in the lower tier (the second tier) to the integrated process selection menu item 122, the process selection menu items of “listen to message” 131 and “dialing” 132 that have been set in the lower tier to the process selection menu item of “telephone” for selecting a telephone function in the full menu, as well as the process selection menu item of “listen to mail” 133 and “stylized reply mail” 134 that have been set in the lower tier to the process selection menu item of “email” for selecting an email function in the full menu are set. Location of these process selection menu items 131 to 134 in the lower tier to the integrated process selection menu item 122 is registered in the menu structure data base 113 as transfer relation information. These process selection menu items 131 to 134 are the menu items that are judged as being used frequently by the menu structure learning/construction unit 111 from the learning value information out of four or more menu items that have been set in the lower tier (the second tier) to the process selection menu item of “navigation” for selecting the navigation function and the process selection menu item of “telephone” for selecting the telephone function in FIG. 10.

Further, in the lower tier (the third tier) to the process selection menu item 132, the process execution menu items of “home ” 141, “office” 142, “recent incoming call and connection” 143, and “number input” 144 that have been set in the lower tiers to the process selection menu item of “dialing” in the full menu are set. Location of these process execution menu items 141 to 144 in the lower tier to the process selection menu item 132 is registered in the menu structure data base 113 as transfer relation information. These process execution menu items 141 to 144 are the process execution menu items that are judged as being used frequently by the menu structure learning/construction unit 111 from the learning value information out of four or more process execution menu items that have been set in the lower tiers (the third tier-fifth tier) to the process selection menu item of “dialing” in FIG. 10.

And as another example with regard to the integrated process selection menu item 122, as shown in FIG. 12, the process selection menu items of “dialing” 152 and “listen to message” 153 for selecting the telephone function, as well as the process selection menu items of “listen to mail” 151 and “stylized reply mail” 154 for selecting the email function may be registered as the second tier, based upon the learning value information of each menu item. Location of the process execution menu items of “redial” 161, “home” 162, “reply to recent incoming call” 163 and “destination facility” 164 in the lower tier (the third tier) to the process selection menu item 152 may be registered as transfer relation information.

Further, operation history information of the process selection menu items and process execution is divided by a weekday, a holiday or an hour belt, and then is stored in the menu structure data base 113. Thereby, when the menu structure learning/construction unit 111 alters the modified menu information by executing the operation menu display process, the specific menu items for process selection and for process execution that have been used frequently can be displayed with priority corresponding to the day or the hour.

[Learning Process]

And the menu structure learning/construction unit 111 carries out learning process that alters a learning value information of each menu item by weighing (learning coefficient) corresponding to an operation of the input device 102. Namely the learning value information with regard to the process selection menu items is calculated such that the operation history information showing how many times the menu items that are set as being located in the lower tier to the menu item based upon the transfer relation information are selected is summed up, and then the summed value is divided by the learning coefficient, thereby to make the learning value information. On the other hand, the learning value information with regard to the process execution menu items is set as operation history information showing how many times the menu item is selected. Renew of the operation history information is performed for each menu item corresponding to detecting the operation of the input device 102 at a state where various menu items are displayed by the menu learning/construction unit 111.

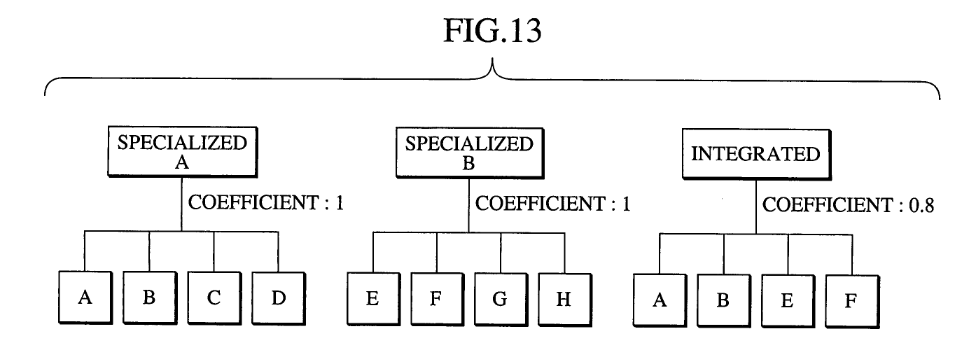

In detail, as shown in FIG. 13, the process selection menu item (Specialized A, for example, “Audio”), the process selection menu item (Specialized B, for example, “Email”), and the integrated process selection menu item contained in the full menu information are present in the same tier, and the menu items A-D are registered in the lower tier to the process selection menu item (Specialized A), the menu items E-H in the lower tier to the process selection menu item (Specialized B), and the menu items A, B, E, and F are registered in the lower tier to the integrated process selection menu item are registered. However, respective menu items shown in FIG. 13 are included in the current modified menu information.

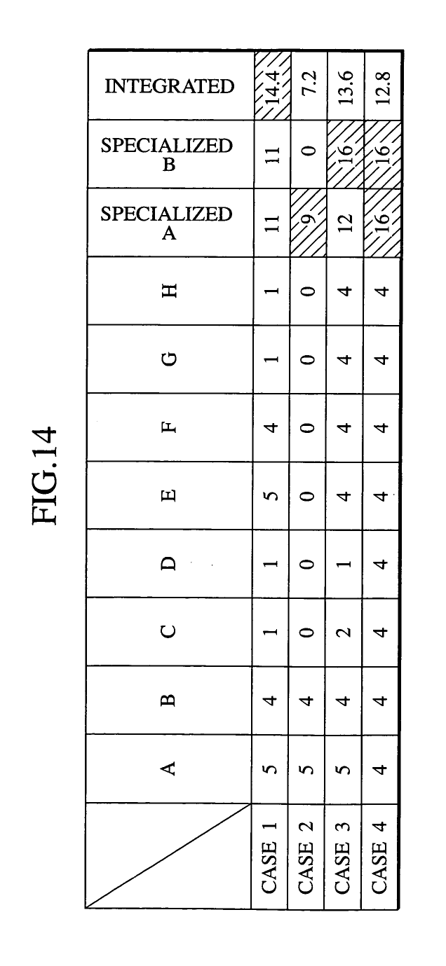

In this situation, in the event the menu structure learning/construction unit 111 recognizes from the operation history information that in the period from when the power source in the information display system S2 is switched on to when it is switched off, as shown in FIG. 14, the menu item A is selected five times, the menu item B is selected four times, the menu C is selected one time, the menu item D is selected one time, the menu item E is selected five times, the menu item F is selected four times, the menu item G is selected one time, and the menu item H is selected one time, the menu structure learning/construction unit 111 sets as the learning value information with regard to the process selection menu item (Specialized A), a value “11” obtained by multiplying a sum “11” of the menu items “A-D” set in the lower tier to the process selection menu item (Specialized A) by a coefficient information “1”. The learning value information with regard to the process selection menu item (Specialized B) is calculated as “11” in the same way with the above-described. And the menu structure learning/construction unit 111 sets as the learning value information with regard to the integrated process selection menu item, a value “14.4” obtained by multiplying a sum “18” of the menu items A, B, E, and F set in the lower tier to the integrated process selection menu item by a coefficient information “0.8”.

Accordingly, the menu structure learning/construction unit 111 controls the display monitor 103 such that, in the event the process selection menu items (Specialized A), the process selection menu items (Specialized B), and the integrated process selection menu items exist in the same tier (for example, the first tier), the integrated process selection menu items with the highest value of the learning value information are displayed as the menu items with the most frequent use.

In the event, as shown in case 2 of FIG. 14, the operation history information shows that the menu item A is selected five times, the menu item B is selected four times, and the menu items C-H is selected 0 times, the learning value information with regard to the process selection menu item (Specialized A) becomes “9”, the learning value information with regard to the process selection menu item (Specialized B) becomes “0”, and the learning value information with regard to the integrated process selection menu item becomes “7.2”. Accordingly, in such case, use frequency in the process selection menu item (Specialized A) is considered to be highest.

Further, in the event, as shown in case 3 of FIG. 14, the operation history information shows that the menu item A is selected five times, the menu item B is selected four times, the menu item C is selected twice, the menu item D is selected is one time and the menu items E-H is selected four times, the learning value information with regard to the process selection menu item (Specialized A) becomes “12”, the learning value information with regard to the process selection menu item (Specialized B) becomes “16”, and the learning value information with regard to the integrated process selection menu item becomes “13.6”. Accordingly, in such case, use frequency in the process selection menu item (Specialized B) is considered to be highest.

Further, in the event, as shown in case 4 of FIG. 14, the operation history information shows that all the menu items A-H are selected four times, the learning value information with regard to the process selection menu items (Specialized A and B) becomes “16”, and the learning value information with regard to the integrated process selection menu item becomes “12.8”. Accordingly, in such case, use frequency in the process selection menu item (Specialized A) or (Specialized B) is considered to be highest.

[Learning Coefficient Setting Process]

The menu structure learning/construction unit 111 calculates a learning coefficient used for the above-described learning process and sets the calculated learning coefficient to be registered in the menu structure data base 113.

Firstly, a process setting a learning coefficient of each menu item in response to positioning of the each menu item in the full menu information and the modified menu information, and the kind of the menu items (for example, the integrated process selection menu item) will be explained.

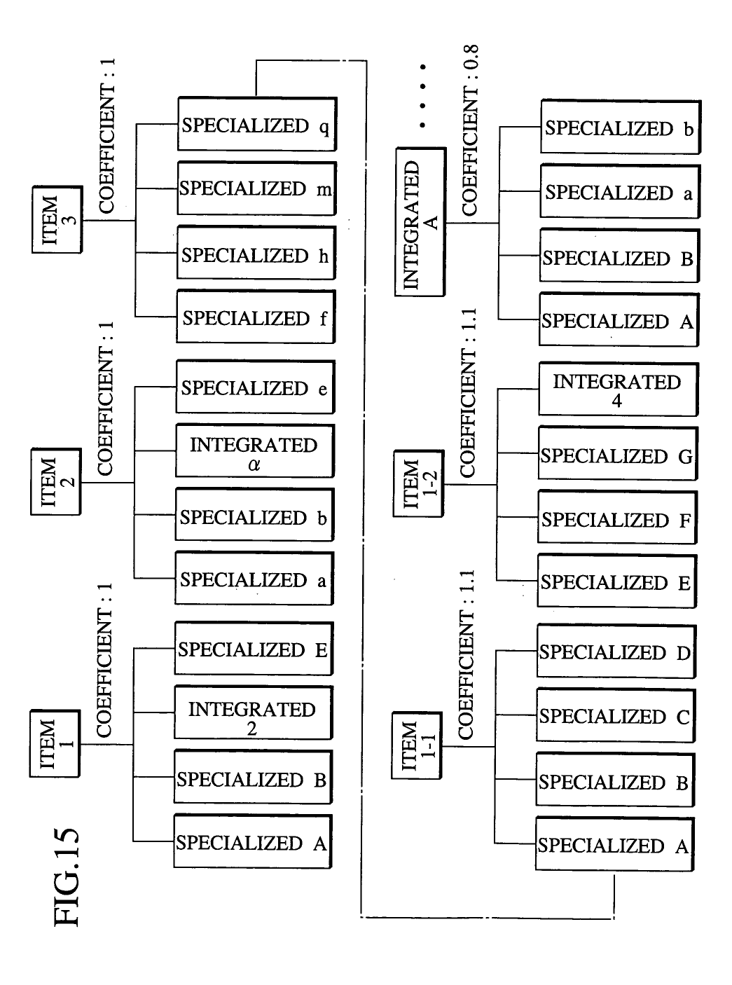

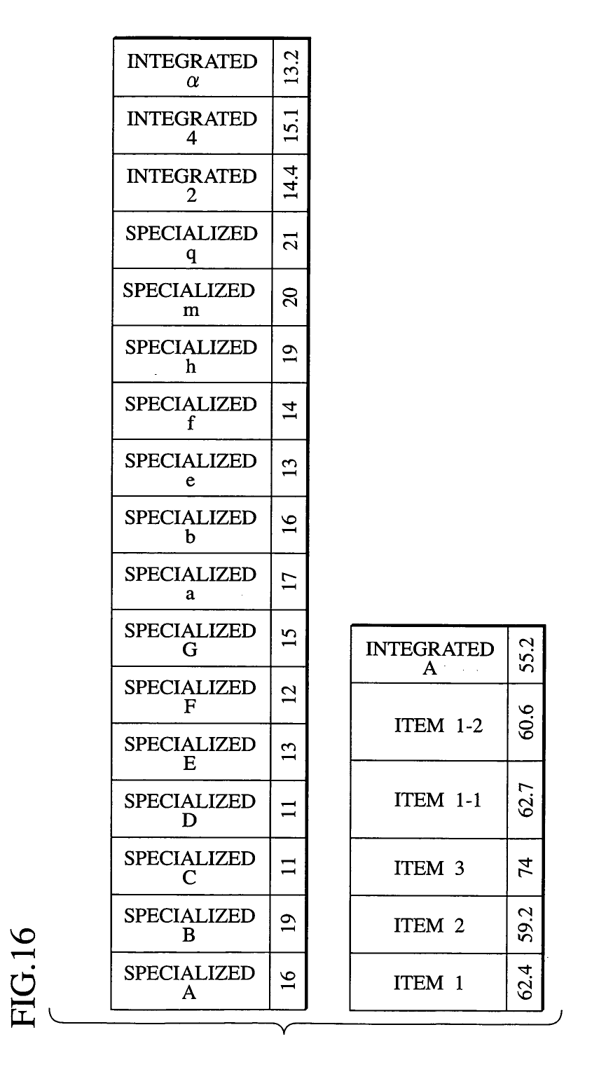

For example, in the event the modified menu information has the first and second tier shown in FIG. 15 and the learning value information of the menu items in each tier has a value shown in FIG. 16, the menu structure learning/construction unit 111 sets the learning coefficient with regard to the process selection menu items (item 1 to item 3) as 1, the learning coefficient with regard to the process selection menu items (item 1-1, item 1-2) as 1.1, and the learning coefficient with regard to the integrated process selection menu item A as 0.8.

Such setting is made due to the following reason. As process selection menu items in a lower tier below the process selection menu items (items 1 and 2), the integrated process selection menu items (Integrated 2 and Integrated α), and menu items (Specialized A, B, E and Specialized a, b, e) which belong in the full menu, to a lower tier of a process selection menu item in a different lineage are registered. As a process selection menu item (item 3) and an integrated process selection menu item (Integrated A), menu items (Specialized f, h, m, q and Specialized A, B, a, b) which belong in the full menu, to a lower tier of a process selection menu item in a different lineage are registered. On the other hand, in the process selection menu items (item 1-1, 1-2), menu items of Specialized A, B, C, D and Specialized E, F, G, which belong in the full menu, to a lower tier of the same process selection menu item are registered.

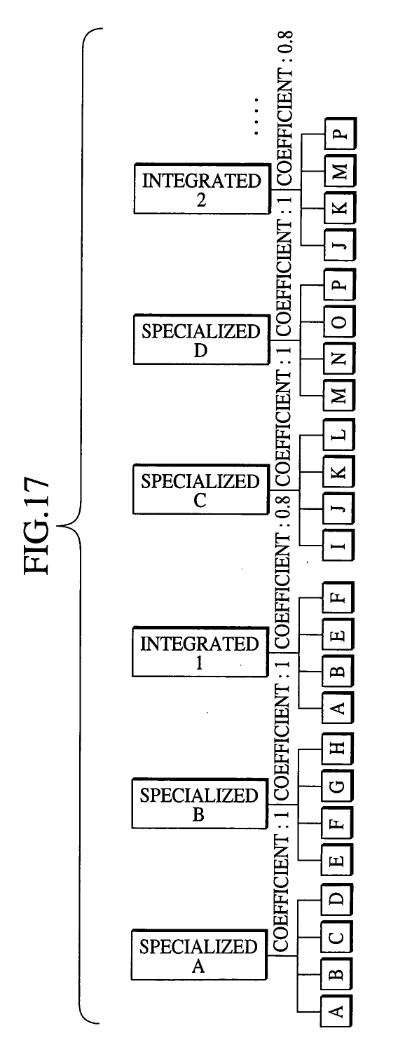

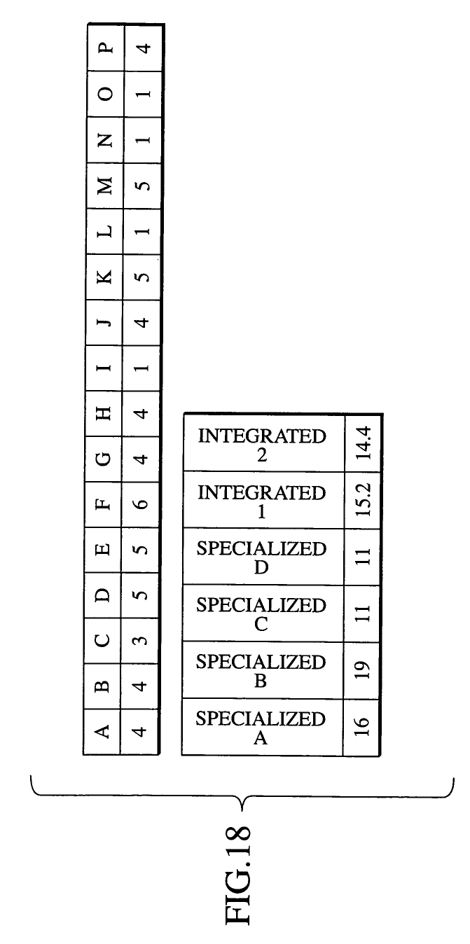

For example, in the event the modified menu information has the second and third tier shown in FIG. 17 and the learning value information of the menu items in each tier has a value shown in FIG. 18, the menu structure learning/construction unit 111 sets the learning coefficient with regard to the process selection menu items (Specialized A, B, C, D) as 1, and the learning coefficient with regard to the integrated process selection menu item (Integrated 1.2) as 0.8.

This is because, in the integrated menu items (Integrated 1 and 2) the menu items located in the lower tier to the process selection menu items different in the full menu are registered, and in the process selection menu items (items 1-1, 1-2), the menu items (Specialized A, B, C, D and Specialized E, F, G) located in the lower tier to the same process selection menu items in the full menu are registered.

Next, another learning coefficient setting process by the menu structure learning/construction unit 111 to change a learning coefficient over time will be explained.

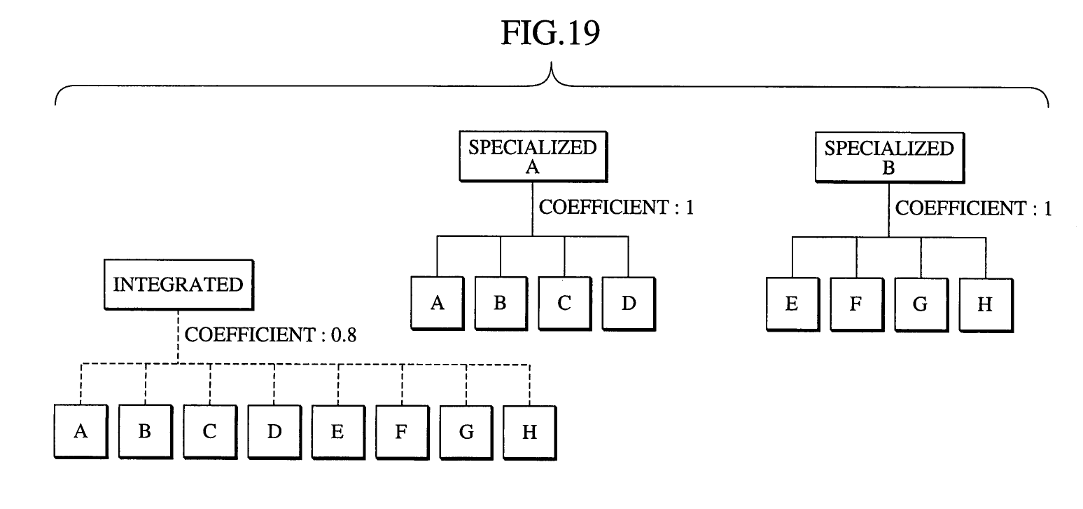

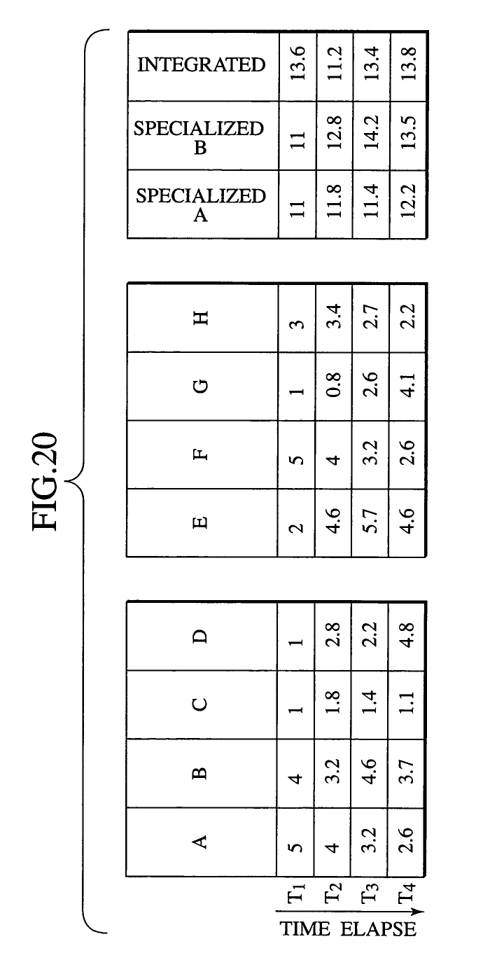

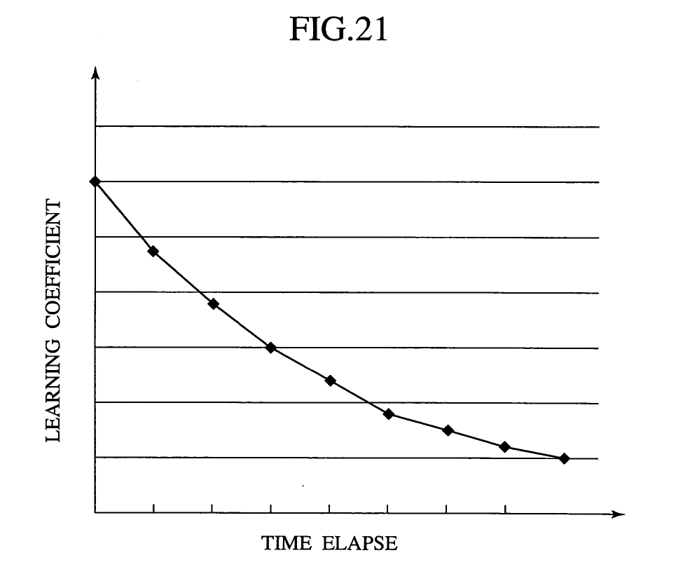

Herein, FIG. 20 shows how an operation history information and a learning value information in each menu item of the modified menu information in FIG. 19 change over time of T1-T4. FIG. 21 shows a change of learning coefficient with time. In the menu structure learning/construction unit 111, when a menu item is not selected for a certain time, a value obtained by multiplying the learning coefficient hitherto by 0.8 for each predetermined unit time elapse is set as a new learning coefficient.

In such process, the menu structure learning/construction unit 111 uses a different learning coefficient respectively to the operation history from the earliest time T1 to the latest time T4.

Namely, in the event, as shown in FIG. 20, the operation history information at time T1 shows that the menu item A is selected five times, the menu item B is selected four times, and the menu items C is selected one time, the menu item D is selected one time, the menu items E is selected twice, the menu item F is selected five times, the menu item G is selected one time, and the menu item H is selected three times, the learning value information with regard to the process selection menu items (Specialized A and B) becomes 11, and the learning value information with regard to the integrated process selection menu item becomes 13.6. And, in the event, the operation history information at the next time T2 shows that the menu item C is selected one time, the menu item D is selected twice, the menu items E is selected three times, the menu item H is selected one time, the menu structure learning/construction unit 111 adds the operation times at time T2 to a value obtained by multiplying a value of the operation history information at time T1 by a learning coefficient 0.8. Thereby, the values of the operation history information in the menu items A, B, F, G not operated at time T2 become respectively 4, 3.2, 4, 3.4, and the values of the operation history information in the menu items C, D, E, H become respectively 1.8, 2.8, 4.6, 3.4. The value of the learning value information in the process selection menu item (Specialized A) becomes 11.8, the value of the learning value information in the process selection menu item (Specialized B) becomes 12.8, and the value of the learning value information in the integrated process selection menu item becomes 11.2.

And when, at time T3 the menu items B, E, G are operated three times and at time T4 the menu items D, G are operated respectively three times and twice, the operation history information and the learning value information as shown in FIG. 20 is obtained by performing the same calculation as described above, using a learning coefficient changing over time as shown in FIG. 21. Thus, the menu structure learning/construction unit 111 decreases the learning coefficient over time, thereby to restrict an increase of the value of the learning value information.

The menu structure learning/construction unit 111 may change the learning coefficient with regard to the menu items of the modified menu information corresponding to, not the relation with the full menu information or the elapse time, but an driving load from the driving load estimation unit 114. On this occasion, when the menu structure learning/construction unit 111 judges that the vehicle is in motion based upon the driving load information, the menu learning/construction unit 111 sets a learning coefficient as high, to increase a learning speed, and when it judges that the vehicle is during vehicle stopped, the menu structure learning/construction unit 11 sets the learning coefficient as lower than during vehicle in motion, to reduce the learning speed.

[Process Routine of Learning Process and Learning Coefficient Setting Process]

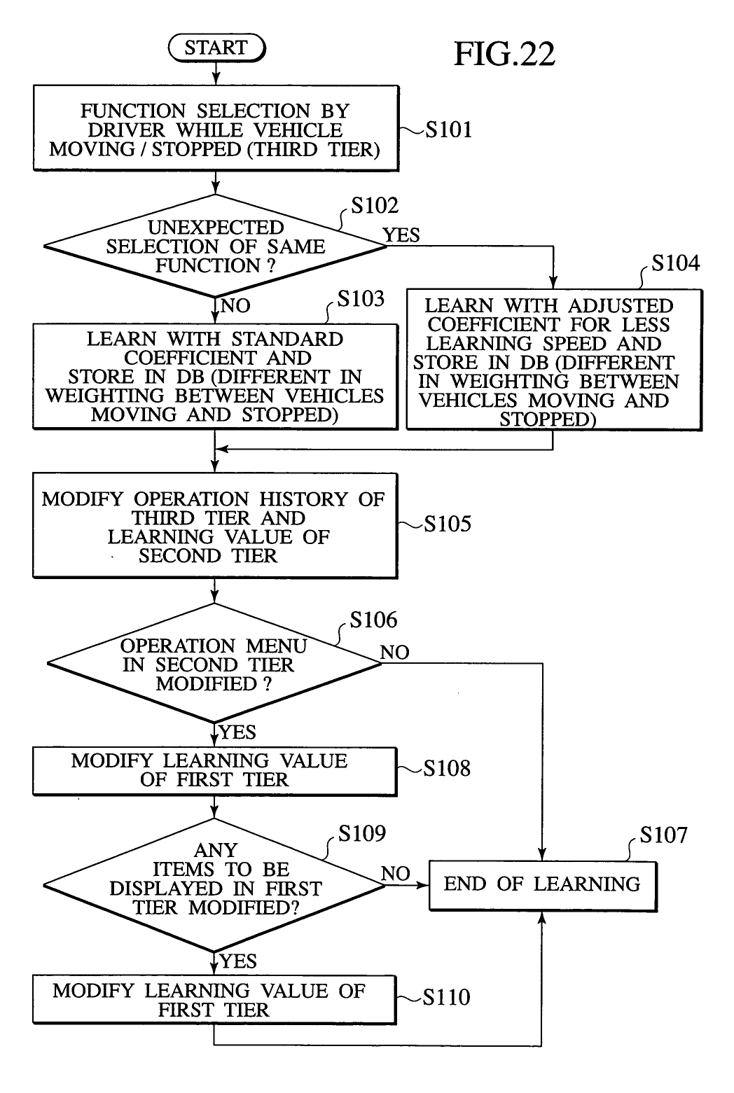

A process routine for the menu structure learning/construction unit 111 with the above-described functions to perform a learning process and a learning coefficient setting process will be explained with reference to a flow chart in FIG. 22. However, a case where the third tier of the modified menu information comprising the first-third tiers is displayed in the display monitor 103 will be explained.

For example, when the operation menu comprising four process execution menu items is displayed at the display monitor 103, a driver operates the input device 102 and then the menu structure learning/construction unit 111 recognizes that any of the process execution menu items is selected (step S101), the process goes to step S102.

In step S102, the menu structure learning/construction unit 111 judges whether or not the driver unexpectedly selects the same process (function) execution menu item. Namely, the menu structure learning/construction unit 111 judges whether or not a process execution menu item is unexpectedly selected at a time, based upon judging whether or not the same process execution menu item is selected for a certain time during working of the information display system S2 more than a predetermined time.

In a case where the menu structure learning/construction unit 111 judges that a process execution menu item is selected less than a predetermined threshold value, the process goes to step S103 by judging that these selections are not unexpectedly operated. On the other hand, in a case where the menu structure learning/construction unit 111 judges that a process execution menu item is selected more than a predetermined threshold value, the process goes to step S104 by judging that these selections are unexpectedly operated.

In step S103 and step S104, the menu structure learning/construction unit 111 executes the above-described learning coefficient setting process.

In step S103, the menu structure learning/construction unit 111 sets a learning coefficient of the process execution menu item operated at step S101 as a predetermined value corresponding to the case where the operation is not unexpectedly performed and stores the predetermined value in the menu structure data base 113 and then the process goes to step S105. The learning coefficient is set as a standard value “1” in a case where it is judged that the operation is not unexpectedly performed at step S102. And in a case where it is judged that the vehicle is in motion based upon a driving load information from the driving load estimation unit 114, the learning value is increased from the standard value “1” to “1.2”. On the other hand, in a case where it is judged that the vehicle is on a stop, the learning coefficient is held as the standard value “1”.

On the other hand, at step S104, the menu structure learning/construction unit 111 sets a learning coefficient of the process execution menu item operated at step S101 as a predetermined value corresponding to the case where the operation is unexpectedly performed and stores the predetermined value in the menu structure data base 113 and then the process goes to step S105. The learning coefficient is set as a standard value “0.8” in a case where it is judged that the operation is not unexpectedly performed at step S102. And in a case where it is judged that the vehicle is in motion based upon a driving load information from the driving load estimation unit 114, the learning value is increased from the standard value “0.8” to “1”. On the other hand, in a case where it is judged that the vehicle is on a stop, the learning coefficient is held as the standard value “0.8”.

At step 105, the menu structure learning/construction unit 111 modifies the operation history information of the process execution menu item selected at step S101 by using the learning process, namely the learning coefficient set at step S103 or S104 and then stores the modified value in the menu structure data base 113. The menu structure learning/construction unit 111 calculates the learning value information for process selection located in the upper tier (the second tier) of the process execution menu item selected at step S101 by using the modified operation history information, and then the process goes to step S106.

At step 105, further, the menu structure learning/construction unit 111 alters the operation history information of the process execution menu items and process selection not selected at step S101 by changing the learning process, namely the learning coefficient over time, as well as modifies the learning value information of each process selection menu item.

At step S106, the menu structure learning/construction unit 111 judges whether or not it alters construction of the operation menu including the process selection menu items in the second tier the learning value information of which is calculated at step S105. Namely the menu structure learning/construction unit 111 judges whether or not it alters the construction of the process selection menu item to be displayed in the second tier out of the process selection menu items registered in the same tier (the second tier) with the process selection menu item the learning value information of which is calculated at step S105.

In a case where the menu structure learning/construction unit 111 judges that the construction of the operation menu in the second tier is not altered, the process goes to step S107 and the learning process ends therein. On the other hand, in a case where the menu structure learning/construction unit 111 judges that the operation menu is altered, the process goes to step S108.

At step S108, the menu structure learning/construction unit 111 modifies the learning value information of each process selection menu item constructing the operation menu in the first tier by using the learning value information of the modified process selection menu item in the second tier on a basis that the process selection menu items constructing the operation menu in the second tier has been altered at step S106 and then the process goes to step S109.

At step S109, the menu structure learning/construction unit 111 judges whether or not it alters the construction of the operation menu in the first tier including the process selection menu items, the learning value information of which is calculated at step S108. Namely the judgment of the construction with regard to the first tier is made in the same way as at step S105.

In a case where the menu structure learning/construction unit 111 does not alter the construction of the operation menu in the first tier, the process goes to step S107, wherein the learning process ends. On the other hand, in a case where the construction of the operation menu is altered, the process goes to step S110.

At step S110, the menu structure learning/construction unit 111 modifies the learning value information of each process selection menu item constructing the operation menu in the first tier by using each operation history information on a basis that the process selection menu items constructing the operation menu in the first tier are altered at step S109 and then the process goes to step S107, wherein the learning process ends.

As explained above, according to the information display system S2 of the second embodiment, in addition to the full menu information, the modified menu information the number of tiers of which is limited than the full menu information is produced and therefore, any of both can be applied corresponding to the driving load. Since the selection times are thus limited to a certain value in consideration of a specific condition such as vehicle in motion, even if the operation menu is altered corresponding to the operation history, the operation burden to users does not increase.

According to the information display system S2, the modified menu information is produced such that the menu item the selection frequency of which is higher is displayed with higher priority based upon the operation history information of each process selection menu item. Therefore, the menu items the users use frequently are displayed with priority, thereby to further reduce the operation burden to the users.

Further, according to the information display system S2, since the operation history is obtained for each of the weekday, the holiday, and the hour belt and thereby the menu items the selection frequency of which is higher are displayed with higher priority in accordance with date and time of use. Accordingly, the operation burden to the users who tend to use different functions depending upon day and time can be reduced.

Further, according to the information display system S2, since the process selection menu items with high use frequency are subdivided to be transferred to an upper tier, thereby to produce the modified menu information, in a case where, for example, destination setting and display setting out of the navigation functions are more frequently used compared with other items, the menu items with regard to these processes can be display in the upper tier.

And also according to the information display system S2, since the modified menu information including the integrated process selection menu items integrating a plurality of different menu items is produced, even if the number of the menu items that can be displayed within one screen is limited, many functions can be selected from the limited menu items, thereby to reduce the operation burden to the users.

And also according to the information display system S2, the learning coefficient is set for the process selection menu items and process execution to alter the operation history with regard to each menu item based upon the learning coefficient, thereby to produce the modified menu information. Therefore, the learning speed of each menu item can be altered corresponding to various situations.

And also according to the information display system S2, since a learning coefficient is set so that a learning speed of the menu items in the lower tier to the integrated process selection menu item becomes smaller than a learning speed of the menu items in the lower tier to the process selection menu item contained in the full menu information, the process selection menu item in the full menu information can be displayed with priority over the integrated process selection menu item. Therefore, an increase of the operation burden to the users caused by frequent display of the integrated process selection menu items the users are not used to is prevented.

According to the information display system S2, since a learning coefficient is set so that after the menu items are selected, a learning speed of the selected menu items that take longer to use is reduced more, display ratio of the menu items used regularly and highly frequently becomes large, thereby to reduce the operation burden to the users.

Further, according to the information display system S2, a learning coefficient is set so that a learning speed becomes faster as a driving load becomes higher, the menu items frequently selected while the vehicle is in motion are thus given priority for being displayed, thereby reducing operation load to the users.

The preferred embodiments described herein are illustrative and not restrictive, and the invention may be practiced or embodied in other ways without departing from the spirit or essential character thereof. The scope of the invention being indicated by the claims, and all variations which come within the meaning of claims are intended to be embraced herein.

The present disclosure relates to subject matters contained in Japanese Patent Application Publication No. 2003-042451, filed on Feb. 20, 2003, and Japanese Patent Application Publication No. 2003-042644, filed on Feb. 20, 2003, the disclosures of which are expressly incorporated herein by reference in its entirety.

What is claimed is:

1. A display system for a vehicle, which presents to a user a plurality of menu items respectively corresponding to functions of devices/equipment mounted on the vehicle by displaying an operation menu including some of the menu items on a screen of a display of the system, and allows the user to select one of the displayed menu items to perform the function thereof, the system comprising:
an input unit to be operated by the user;
an operatability judgment unit which judges user's operatability of the input unit;
a storage unit which stores hierarchically structured first menu information, the first menu information comprising a plurality of the operation menus respectively registered in a plurality of tiers of the first menu information; and
a display control unit which determines the operation menu to be displayed on the screen, based upon the operatability of the user judged by the operatability judgment unit, using the first menu information or a second menu information having a limited number of tiers as compared with the first menu information.

2. A display system according to claim 1, further comprising:
a driving load determination unit which determines a driving load on the user who drives the vehicle, wherein
the storage unit stores the first and second menu information, and
the display control unit determines, based upon the determined driving load and the operatability of the user, a timing when to shift from a process of displaying the operation menu using the first menu information to a process of displaying the operation menu using the second menu information.

3. A display system according to claim 2, wherein
the operatability judgment unit monitors operation time of the user to judge the operatability of the user, and changes the number of tiers of the respective first and second menu information, based on the operatability.

4. A display system according to claim 2, wherein
the display control unit allows a continuous operation of the input unit if the number of remaining operation steps is less than a predetermined step number at a point where it is judged, based upon the driving load, that the process of displaying the operation menu using the first menu information will be shifted to the process of displaying the operation menu using the second menu information, while the input unit is operated.

5. A display system according to claim 4, wherein
the number of tiers of the second menu information is increased when the user frequently carries out the continuous operation of the input unit.

6. A display system according to claim 4, wherein
an amount of steering wheel operation is recorded while the operation menu using the second menu information is displayed, and the number of tiers of the second menu information is decreased in a case where the amount of steering wheel operation is large.

7. A display system according to claim 2, wherein
the operatability judgment unit judges the operatability of the user by monitoring an operation time thereof while displaying the operation menu, and records an average operation time and amount of steering wheel operation while displaying the operation menu, thereby calculating a limit amount of steering wheel operation at a point where the average operation time exceeds a predetermined value, and stops displaying the operation menu in a case where an amount of steering wheel operation exceeds the limit amount thereof.

8. A display system according to claim 2, wherein
the operation menu using the second menu information is displayed while an amount of steering wheel operation is small, and when the amount thereof is increased before an operation step of the operation menu ends, the display control unit allows to continue only one step operation in the event the number of remaining operation steps is one.

9. A display system according to claim 1, wherein
the operatability judgment unit comprises a driving load estimation unit that estimates a driving load of the user,
the first menu information is a full menu information that comprises a selection operation menu including a plurality of selection menu items for selecting functions of the vehicle-mounted devices, registered to a plurality of tiers; and an execution operation menu including a plurality of execution menu items for executing functions of the vehicle-mounted devices registered in a tier lower than the plurality of the tiers of the selection operation menu,
the second menu information is a modified menu information that is produced by modifying the full menu information, and
the display control unit comprises a menu production unit that produces the modified menu information, wherein the display control unit displays the operation menu by using the full menu information or the modified menu information based upon the estimated driving load.

10. A display system according to claim 9, wherein
the menu production unit produces the modified menu information so that the menu item that is selected more frequently is displayed with higher priority, based upon an operation history information of each of the selection menu items and the execution menu items.

11. A display system according to claim 10, wherein
the menu production unit produces operation history information for each menu item divided by a weekday, a holiday or an hour belt, thereby to produce the modified menu information such that the menu item that is selected more frequently corresponding to the weekday, the holiday or the hour belt is displayed with higher priority.

12. A display system according to claim 9, wherein
the menu production unit subdivides the selection menu item that is used frequently and produces the modified menu information comprising the subdivided selection menu item transferred to a upper tier.

13. A display system according to claim 9, wherein
the menu production unit produces the modified menu information comprising a selection integrated menu item that integrates a plurality of different menu items.

14. A display system according to claim 10, wherein
the menu production unit sets a learning coefficient that alters a learning speed for each of the selection menu item and the execution menu item, and alters the operation history information of each menu item based upon the learning coefficient.

15. A display system according to claim 14, wherein
the menu production unit produces the selection integrated menu item that integrates a plurality of different menu items, and sets the learning coefficient so that a learning speed of the menu item in a lower tier to the selection integrated menu item becomes slower than a learning speed of the menu item in a lower tier to the selection menu item contained in the full menu information.

16. A display system according to claim 14, wherein
the menu production unit sets the learning coefficient so that the learning speed gets slower as a time elapse after each menu item has been selected becomes longer.

17. A display system according to claim 14, wherein
the menu production unit sets the learning coefficient so that the learning speed gets faster as the estimated driving load is larger.

18. An information display system for a vehicle comprising:
a display device that displays an operation menu, the operation menu including a plurality of menu items corresponding to a function of a vehicle-mounted device;
an input unit that selects the menu items of the operation menu displayed; and
a controller that displays the selected menu items on the display device, the controller comprising:
an operatability judgment unit that judges an operatability of a user with respect to the input unit;
a storage unit that stores a first menu information registering the operation menu to a plurality of tiers; and
a display determination unit that determines the operation menu to be displayed by selecting the first menu information or the second menu information a number of tiers of which is limited compared with the first menu information corresponding to the operatability of the user.
